(19) United States
(12) Patent Application Publication
(10) Pub. No.: US 2007/0075835 A1
(43) Pub. Date: Apr. 5, 2007

(54) ENCAPSULATED TRANSPONDER AND METHOD FOR MANUFACTURING THE SAME

(76) Inventors: JEAN-MIGUEL ROBADEY, Bossonnens (CH); ANDRE MEILLAND, ATTALENS (CH)

Correspondence Address: SHERIDAN ROSS PC, 1560 BROADWAY, SUITE 1200, DENVER, CO, 80202, US

(21) Appl. No.: 11/536,964

(22) Filed: Sep. 29, 2006

(30) Foreign Application Priority Data
Oct. 3, 2005 (EP) 05109156.9

(51) Int. Cl. H04Q 5/22

(52) U.S. Cl. 340/10.1; 340/572.8; 340/572.7

(57) ABSTRACT

The invention concerns an encapsulated transponder (1) having an integrated circuit (2), an antenna (3) and one or more electrical connections (4) between the integrated circuit (2) and the antenna (3). At least a part of the transponder (1) comprising the electrical connections (4) is embedded within a capsule (6) that is removable without damaging the electrical connections (4). Also claimed is a method for the production of such a transponder (1).

### CROSS REFERENCE TO RELATED APPLICATIONS

This Application claims the benefit of European Patent Application Number 05109156.9, filed Oct. 3, 2005, the entire disclosure of which is hereby incorporated herein by reference.

### FIELD OF THE INVENTION

The invention relates to a transponder as installed primarily in devices for identification of objects of various types, including persons or animals, and to a method of encapsulating such transponders. More particularly, the invention relates to providing a removable capsule of encapsulating material around at least the connections between the ends of an antenna and an integrated circuit.

### BACKGROUND

Transponders are well known in the art and generally comprise an electrical circuit having an antenna connected to an integrated circuit. The transponder is responsive to a received radio frequency signal and produces a radio frequency signal.

Beside the connection of the two electric elements of the electrical circuit, a key step in the manufacture of a transponder is the removable encapsulation of the electrical circuit or components thereof in order to protect the encapsulated components and electrical connections from mechanical shocks and from soiling, to ensure a durable mechanical connection between the two circuit elements, and to give the transponder a size allowing it to be better handled.

To ensure a perfect functionality of the transponder, the packaging has to be totally adapted to the nature of the final application and to specifications defined by the user. The final product can be, as non-limiting examples, a glass mini-tube, a plastic coin token or a contactless smart card. Due to the popularity of Radio Frequency Identification (RFID) technology in an increasing number of fields of activity, there are more and more demands for special types of packaging.

It is not always desirable, from an economical point of view, for a transponder manufacturer to perform all the production steps up to the final product. For example, it can be of high interest to effectuate the final packaging steps, for example:

in the proximity of or even by the customer

in a separate packaging manufacture unit

where the manufacturing costs are lower

where the packaging material is cheaper and available in great quantity.

To allow the transport and manipulation of the electrical circuit of the transponder, it must be protected against damages, such as from adverse mechanical (such as shocks, transport vibrations, pressure, stress) or chemical (as moisture, oxidation, corrosion) interactions or other types of harmful events. Accordingly, to reduce or prevent damage, different types of pre-packaging are used to support and encapsulate the electrical circuit.

In the case of contactless smart cards, where packaging dimensions are defined by ISO standards, it is usual to use flexible plastic sheets, generally of PVC, as a support to deposit the electrical circuit thereon or therein if the sheet has cutouts. Additionally, an overlying cover sheet can be added (by lamination, injection, deposition or curing) to encapsulate the electric circuit and form an inlay or a final product. Such inlays, that are about 350 micrometers thick, are industry standards. Additional overlying sheets may be added to enhance the final product.

The encapsulation must be adapted to the structure the electrical circuit of the transponder, especially to the nature of the connections between the antenna coil and the integrated circuit. One method of producing transponders is to connect the antenna coil directly onto metal contacts on the integrated circuit. Such a method of producing transponders is referred to as direct bonding. For example, in the case of a conductive wire as antenna coil, one can use thermocompression (with the aid of a punch) to cause the metals to interact, and the conductive wire to adhere to the surface of a contact on the integrated circuit. The bonding pads on the integrated surface also may be enlarged to facilitate connection of the antenna and integrated circuit contacts.

However, following bonding of the conductive wire to the contact on the integrated circuit, the conductive wire, being filament-like and of small dimensions, may undergo shearing or fatigue caused by the filament pressing against the edge of the chip. Such direct bonding configurations are particularly sensitive to mechanical stress and vibrations, as the integrated circuit is sometimes solely supported by the conductive wire.

There exist a number of processes to solve this problem, some of which involve the encapsulation and immobilization of the soldering or bonding points between the integrated circuit and the conductive wire. However, in a great majority of the cases these processes result in very rigid systems, causing the conductor itself to break outside or at the edge of the encapsulation and thus disqualifying these methods for use in the manufacture of transponders.

Furthermore, encapsulations are expensive in practice because they involve a sequence of steps to prepare the integrated circuits for encapsulation. Very often these are heat-related processes, capable of compromising the operation of the integrated circuits, which are sensitive to sudden temperature changes.

U.S. Pat. No. 6,687,131 describes a transponder, whose the electrical circuit is permanently encapsulated in a polyamide thermoplastic resin (hot glue) by low pressure injection. The electrical circuit is placed in a bottom mold half. Once the mold has been closed by applying a top mold half, liquid hot glue is injected between the mold halves at approximately 200 degrees C. at a low pressure of about 20 bar. This process of manufacture exposes the circuits to less stress than conventional injection molding. As the mold does not normally need to be heated, it can be made of inexpensive material such as plastic or aluminum and can be incorporated in the transponder itself. Advantageously, the transponder is protected from pressure and temperature especially during further processing, as for example a conventional injection molding process, and the components are held firmly in place.

Such solutions have a number of drawbacks. In particular, they are multi-step processes that slow down the overall manufacturing process. Their conditions (temperature, pressure and chemicals) are different from the electronic assembly of the components and because of the chemicals and chemical processing involved, additional measures have to be taken to avoid interaction in the production area, such as off-line processing. These processes also use a relatively large amount of additional material, as whole sheets of support or molds.

Another solution is proposed in Brazil Pat. No. 0202961. With the aim to protect the conductor-to-chip connections, a process is disclosed which involves an immersion of the entire integrated circuit, including the connections to the antenna, in photopolymerizable resin followed by exposure to ultraviolet radiation. This process results in a protective membrane that provides protection to the connections and product durability and reliability. Unfortunately, such a process is not suitable for use in temporarily pre-packaging a transponder, as the resulting cured capsule is almost impossible to release without damaging the electronic circuit. That makes it chemically and/or mechanically incompatible with particular final uses, including final packaging. The protection capsule slightly increases the weight and dimensions of the transponder. Photopolymerizable resins are expensive substances that are not chemically inert (previous to curing) and require special measures to be used in a manufacturing environment. The use of UV-curing radiation also implies the use of special protection measures of the manufacturing personnel and devices.

### SUMMARY OF THE INVENTION

It is an aim of the present invention to improve radio frequency transponders and processes for making them.

It is also an object of the invention to embed the electrical connections between the integrated circuit and antenna of a transponder in a protective capsule.

It is another object of the invention to provide a simple and inexpensive method for manufacturing such a transponder.

It is another object of the invention to provide a capsule material that is temporary, such as for purposes of shipping and handling, and that can be simply and inexpensively removed prior to final packaging without damage to any components of the transponder.

These and other objects are achieved by the features of the transponder and by the method of production of such a transponder defined in the claims.

In embodiments of the invention, the electrical connections between the integrated circuit and the antenna are embedded within a capsule that supports and secures the electrical connections. The capsule can be malleable, also with a capacity to absorb small amounts of mechanical energy without transmitting them to the electrical connections, providing a good protection against stresses, shocks and vibrations common during transportation and shipping.

The capsule is easily removable from the connections without risking damage to the electrical connections. There is a variety of different and simple (mechanical or chemical) techniques that allow the capsule to be detached from the transponder without damaging the electrical connections. For example, the material of the capsule is preferably soluble in a large variety of common and cheap solvents (that are neutral against the other elements of the transponder) allowing the capsule material to be easily washed out or removed. This allows the capsule to be used as a pre-packaging means suitable to protect the transponder during shipping, transport and storage, without being an insurmountable obstacle for any final packaging treatments or uses.

In accordance with another embodiment of the invention, at least a part of the integrated circuit and a part of the antenna are embedded by a capsule in such way that the capsule holds the integrated circuit and the antenna in a specific mutual relative position. Due to the malleability of the capsule, an interesting property is that the specific mutual relative position is not fixed definitively, but could be changed by careful manual or mechanical processes. Such a capsule is very useful for types of transponders where the integrated circuit is supported only by the antenna before the encapsulation. This is more often the case when the antenna is a conductive wire that is connected by direct bonding to the integrated circuit. The malleable capsule is useful in these circumstances because the relative position of the integrated circuit and the antenna may vary from one capsule to the next. However, the arrangement of the antenna and integrated circuit can be carefully adjusted to fit into preformed shipping containers prior to shipping and, the malleability of the capsule will further provide protection to the electrical connections from impact during shipping.

A particular advantageous embodiment of the invention is to use wax or paraffin as capsule material. Wax is an inexpensive material, chemically inert and easy to handle, solid or melted. It is malleable at normal ambient temperatures, has a reasonably low melting point and has a relatively low viscosity when melted (unlike many plastics). Chemically, wax is insoluble in water (is even hydrophobic), but is soluble in most organic solvents, including alcohols, ethers, and esters.

Embodiments of the invention also relate to a method of encapsulating a transponder characterized in that at least the part of the transponder comprising the electrical connections between the integrated circuit and the antenna is submerged or dipped in a coating liquid in such a way as to create a capsule that supports and secures the electrical connections, and that the said capsule can be easily removed without damaging the electrical connections. The dipping method per se is simple and known in the art. It has been long used to create protective covering of electronic elements. The difference is that the resulting capsule of the present invention not only protects the electronics against physical impact and chemical attacks, but also mechanically supports and secures the electrical connection between the integrated circuit and the antenna of the transponder. In many types of transponders the antenna and the integrated circuit have no common support. Due to this, the electrical connection is particularly sensitive to any mechanical stress or vibration that tends to change the position of the antenna relative to the integrated circuit.

A particular advantageous embodiment of the invention is to heat the transponder at a temperature higher than the fusion temperature of the coating liquid. This allows a faster and more uniform embedding of the transponder by the coating liquid.

Another particular advantageous embodiment of the invention is to carry out testing or other types of the control of RFID functionalities of the transponder by use of a RFID reader during the dipping step.

Another embodiment of the invention relates to a method of encapsulating a transponder by dipping it in a coating liquid and curing it by exposing the coating liquid to a flux of air at ambient temperature for a given amount of time. The solidification and finishing of the capsule does not require any complex manufacturing steps, drying furnace, special radiation apparatus (as UV) or even molds of any kinds. In the case of melted coating liquid, such as melted wax or paraffin, the curing phase is used to cool down at least the external envelop of the capsule.

### BRIEF DESCRIPTION OF THE DRAWINGS

The invention will be better understood in the text below together with the following drawings:

FIG. 1 illustrates a method for producing a transponder according to embodiments of the invention;

FIGS. 2A and 2B show a first type of transponder according to embodiments of the invention; and

FIGS. 3A and 3B show a second type of transponder according to embodiments of the invention.

### LIST OF NUMERICAL REFERENCES

1 transponder
2 integrated circuit (IC)
3 antenna
4 electrical connections
5 coating liquid
6 capsule
7 holding means
8 coating basins
9 thermocouple
10 heating body
11 laser detection means
12 hot air blower
13 RFID reader antenna
14 container
15 integrated circuit contact pads

### DETAILED DESCRIPTION

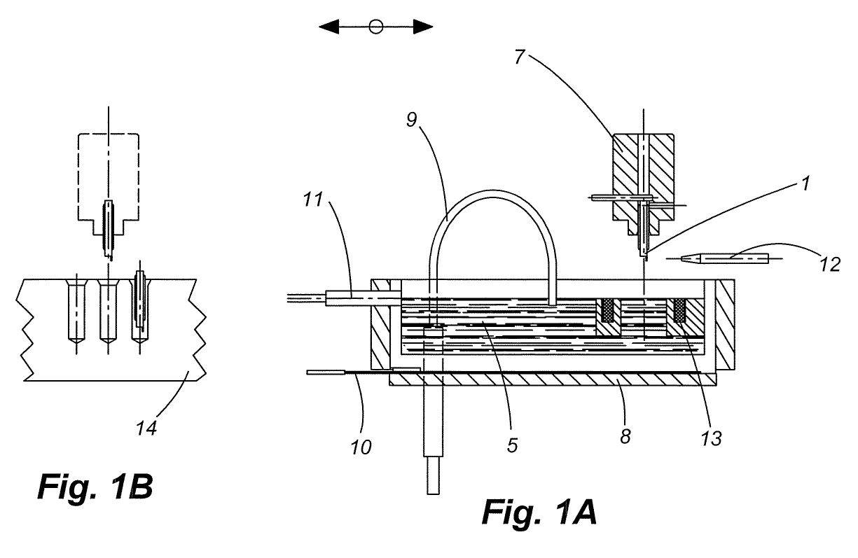

The embodiment shown in FIG. 1 comprises holding means 7, holding the transponder 1 in a vertical position above the coating basin 8. The holding mechanism could be, for example, a system utilizing magnets, vacuums, or a combination of both.

In one embodiment, the encapsulant or coating liquids in the coating basin 8 is preferably a high temperature wax such as bees wax or a high temperature paraffin. The term high temperature means the melting temperature of the encapsulant is high. Concretely, a wax referenced Micro No 17 of ETS Jacques Vernet, with a fusion temperature of 86° C. can be used. To maintain a high homogeneity of the melted wax 5 during the process, the wax is maintained at a temperature of about 110° C. by way of a regulation temperature circuit comprising a thermocouple 9, a regulator (not shown) and a graphite heating body 10.

A laser detection means 11 is used to detect if the encapsulant or coating liquid 5 is below a given level. If the coating liquid 5 is below a given level, a signal is emitted that indicates that more encapsulant material should be added in the basin 8. The addition of encapsulant can be achieved manually by an operator or by automated mechanisms.

Well known to one skilled in the art is the necessity that after the bonding of the antenna to the integrated circuit, the transponder has to be heated to allow a stress release. A hot air blower 12, for example, may carry out the heating task. In one embodiment of the invention, this heating step can be slightly adjusted for the additional functionality to pre-heat the transponder to a temperature higher than the fusion temperature of the coating liquid 5. A Leister hot air blower 12 of the type Diode PID may be used to heat the transponder 1 for about 1 second with an air flux at a temperature of about 280° C. and pressure of about 8 mbars. Preferably, the heating system will cause the transponder to reach a uniform temperature. For this purpose, a multi-nozzle blower may be advantageously used.

After the pre-heating step, the holding means 7 is moved down to a given position in order to place at least the part of the transponder 1 comprising the electrical connections 4 between the integrated circuit 2 and the antenna 3 into the coating liquid. The further the transponder 1 is moved down in the coating liquid 5, the larger the part of the transponder 1 embedded in the resulting capsule 6 will be. In one embodiment, the dipping time is below 1 second. As can be appreciated, the actual dipping time depends on the type of encapsulating material (e.g. wax) used and if the transponder 1 is pre-heated or not.

Once the dipping is terminated, the holding means 7 is brought back to its original position, where the transponder 1 is held outside of the coating liquid 5. A part of melted wax is now adhering to the transponder 1 in the form of an embedding film that forms the desired capsule 6. In order to reach a homogeneous and mechanically stronger state, the still hot wax is cooled down rapidly. To avoid any damage to the electrical components, the cooling should not be achieved by dipping the transponder 1 in cold water. One proposed solution is to submit the transponder 1 with its hot capsule 6 to a flux of pressurized air at ambient or below ambient temperature for about 1 second. Such air-pressurized means are well know in the art and are not represented on the figure.

After the solidification step, the transponder 1 is positioned in a container 14. Multiple transponders may be placed in the container. The holding means 7 may move to the container, or both the holding means 7 and container 14 may move relative to each other. The container 14 may have a honeycombed structure to accommodate one or more transponders 1 deposited in a defined position therein. In one embodiment, the defined position of the transponder 1 in the container 14 is such that the transponder can be easily re-gripped after placement of the transponder 1 in the container 14.

Additionally represented in the FIG. 1 is an RFID reader antenna 13, which is mounted inside of the coating basin 8. The antenna 13 is positioned in order to facilitate testing and other types of control over the RFID functionalities of the transponder 1 during the dipping step. Another preferred embodiment, would be to place the reader antenna 13 on or integrate the reader antenna 13 in the holding means 7 in order to effectuate the control of the transponder 1, for example, on the move during transponder 1 transport to the container 14. Alternatively, the RFID reader antenna 13 can be mounted above the basin 8, in order to be able to effectuate the control during (simultaneously to) the pre-heating step, or during the solidification step.

The transponders may now be shipped or otherwise transported to a different location for further processing or assembly, for example, to a separate packaging manufacturer or a customer. The capsule provides mechanical and chemical protection to the transponders during transport. As part of further assembly or final packaging, the capsule may be simply and inexpensively removed by application of heat. However, due to the nature of the capsule material, the level of heat needed is much less than that of prior art encapsulating materials and will not damage the transponder components. The amount of heat needed is that which will heat the capsule to between 86° C. and 110° C. With the capsule removed, the final packaging may be smaller and therefore more optimal for the end use of the transponder.

Representative embodiments of a transponder according to the invention will now be illustrated by describing two particular types of transponders.

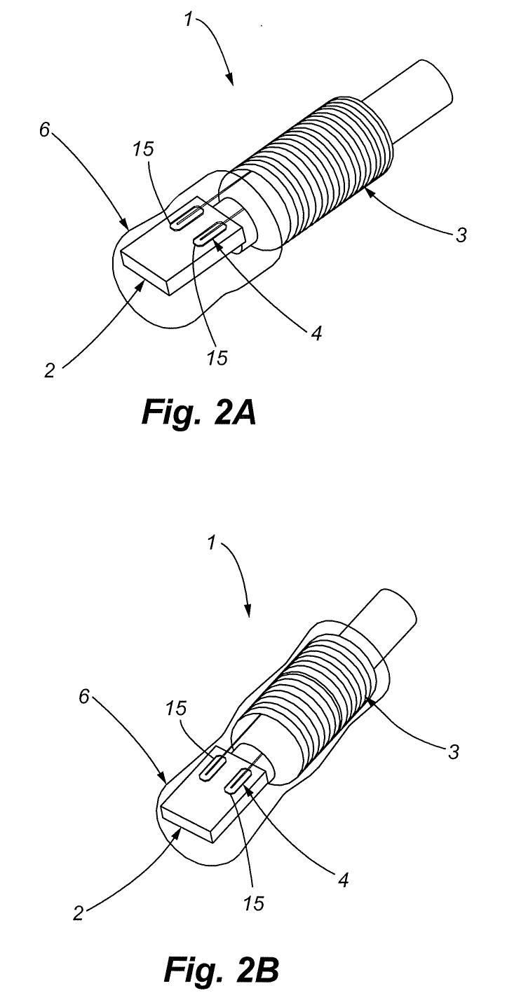

In FIGS. 2A and 2B, rod unit type transponders 1 according to embodiments of the invention are represented. This type of transponder 1 is characterised in that the antenna 3, formed by a conductive wire has a cylindrical form and is wound around a ferrite rod. The integrated circuit 2 is directly bonded to the antenna 3, as the extremities or leads of the antenna wire 3 are directly bonded on contact pads 15 of the circuit 2. These connections 4 ensure both the electrical functionalities of the transponder 1 and the mechanical holding of the integrated circuit 2 relative to the antenna.

In FIG. 2A, the capsule 6 embeds the integrated circuit 2 and the ends of the wire antenna 3. In FIG. 2B, the capsule 6 additionally embeds the totality of the antenna 3. The dipping depth of the rod unit transponder 1 in the coating liquid 5 can easily control the variation of the coverage of the antenna 3 by the capsule 6.

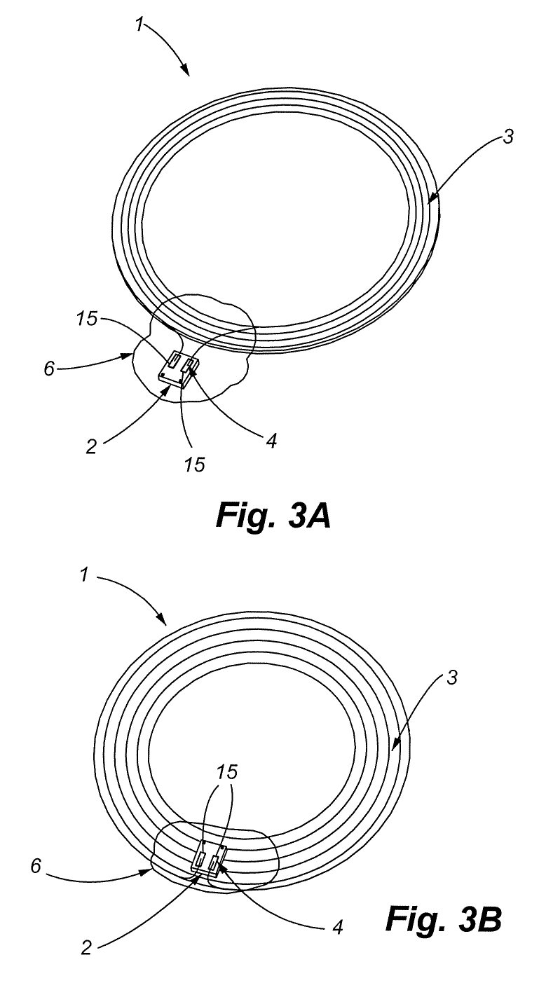

In FIGS. 3A and 3B, concentric disc shape transponders 1 according to embodiments of the invention are shown. Such transponders comprise a disk shaped antenna coil 3, having conductive wires wound to form an air-core coil, and an integrated circuit 2 directly bonded to both leads or ends of the antenna 3 by the connections 4. The integrated circuit 2 can be alternatively positioned outside of the area defined by the antenna, as in the FIG. 3A, on the antenna, as shown in FIG. 3B, or inside of the area defined by the antenna 3 (an embodiment that is not illustrated here).

In FIG. 3A, the capsule 6 solely embeds the ends of the antenna wire 3, a portion or segment of the coil and the integrated circuit 2 that is positioned outside of the area defined by the antenna 3. In FIG. 3B, previous to the dipping, the antenna wire has been bent in order to position the integrated circuit 2 on the antenna 3. In this embodiment, the capsule 6 embeds the integrated circuit 2 and the part of the disc shape antenna 3 on which it is positioned, including the ends of the antenna wire 3.

As noted above, with respect to FIG. 1, the transponders may then be placed in appropriate packaging for transfer to another location for additional processing or final packaging. The capsule may or may not be removed, depending upon the nature of the final packaging. If it is removed, removal can be accomplished at a safe temperature without damage to the integrated circuit, antenna or their connection.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

While various embodiment of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A transponder, comprising:
an integrated circuit;
an antenna; and
one or more electrical connections between the integrated circuit and the antenna, wherein at least a part of the transponder comprising the electrical connections is embedded within a capsule that supports and secures the electrical connections, the capsule being removable from the transponder without damaging the electrical connections.

2. The transponder according to claim 1, wherein at least a part of the integrated circuit and a part of the antenna are embedded in the capsule in such way that the capsule holds the integrated circuit and the antenna in a specific relative position.

3. The transponder according to claim 1, wherein the antenna is directly connected onto the integrated circuit.

4. The transponder according to claim 1, wherein the antenna comprises a conductive wire.

5. The transponder according to claim 1, wherein the capsule is malleable.

6. The transponder according to claim 1, wherein the capsule comprises at least one of wax and paraffin.

7. The transponder according to claim 5, wherein the malleable nature of the capsule permits the position of the integrated circuit to be changed relative to the antenna without damaging the electrical connections between the integrated circuit and antenna.

8. The transponder according to claim 1, wherein the capsule is removable by application of heat to the capsule and wherein the capsule temperature does not exceed approximately 110° C.

9. A method for producing a transponder having an integrated circuit, an antenna, and one or more electrical connections between the integrated circuit and the antenna, comprising:
a) at a first location, submerging at least a part of the transponder comprising the electrical connections in a coating liquid resulting in a capsule that covers the electrical connections and supports and secures the electrical connections;
b) transporting the transponder to a second location;
c) removing the capsule from the transponder at the second location without damaging the electrical connections.

10. The method according to claim 9, further comprising:
before the submerging step, pre-heating the transponder to a temperature higher than the fusion temperature of coating liquid.

11. The method according to claim 10, wherein said fusion temperature of said coating liquid is between about 86° C. and about 110° C.

12. The method according to claim 9, further comprising:
after the submerging step, exposing a part of the coating liquid embedding the transponder to a flux of air to solidify at least a part of the coating liquid.

13. The method according to claim 9, further comprising:
controlling Radio Frequency Identification (RFID) functionalities of the transponder with an RFID reader during the submerging step,

14. The method according to claim 9, wherein the coating liquid comprises at least one of melted wax and paraffin.

15. The method according to claim 9, further comprising adding final packaging to the transponder after the capsule is removed from the transponder.

16. The method according to claim 9, further comprising adding final packaging to the transponder before the capsule is removed from the transponder.

17. The method according to claim 9, further comprising further processing the transponder following removal of the capsule.

18. The method according to claim 9, wherein removing the capsule from the transponder comprises heating the capsule to no more than approximately 110° C.
